(19) United States
(12) Patent Application Publication
(10) Pub. No.: US 2026/0281794 A1
(43) Pub. Date: Sep. 17, 2026

(54) Radio Network Node, Network Node, and Methods Performed Therein

(71) Applicant: Telefonaktiebolaget LM Ericsson (publ), Stockholm (SE)

(72) Inventors: Nianshan Shi, Järfälla (SE); György Miklós, Pilisborosjenö (HU); Paul Schliwa-Bertling, Ljungsbro (SE)

(21) Appl. No.: 19/469,049

(22) PCT Filed: Mar. 28, 2024
(86) PCT No.: PCT/EP2024/058438

§ 371 Date: Sep. 25, 2025

Related U.S. Application Data
(60) Provisional application No. 63/493,318, filed on Mar. 31, 2023.

(51) Int. Cl. H04W 28/02; H04W 76/12

(52) U.S. Cl. CPC H04W 28/0268; H04W 76/12

(57) ABSTRACT

Embodiments herein relate to a method performed by a network node for handling communication in a communication network. The network node sets up a separate tunnel for a time sensitive QoS flow.

### TECHNICAL FIELD

Embodiments herein relate to a radio network node, a network node, and methods performed therein regarding wireless communication. Furthermore, a computer program product and a computer readable storage medium are also provided herein. In particular, embodiments herein relate to handling communication, such as time sensitive traffic, in a communication network.

### BACKGROUND

In a typical communication network, user equipments (UE), also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the Network Repository Function (NRF).

The fifth generation of mobile technology (5G) is positioned to provide much wider range of services, including Mission Critical Services, such as Critical Machine Type of Communication (C-MTC). The C-MTC Use Case group covers a big set of applications, but most of them can be characterized by low latency and high reliability. The Time-Sensitive Networking (TSN) Task Group of IEEE 802.1 provides a standardized solution for satisfying low latency and high reliability requirements in fixed Ethernet networks. 3GPP has defined an integration mechanism into TSN networks, so that 3GPP networks can also act as virtual bridges, 5G system (5GS) bridge on a per user plane function (UPF) granularity. The 3GPP work focuses on a fully centralized network model scenario where a Centralized Network Controller (CNC) provides the configuration for the TSN bridges. In the control plane, the TSN application function (AF) function provides the signalling interface between the CNC controlling the TSN network and the 3GPP network functions. In the user plane, device side (DS)-TSN Translator (TT) ports correspond to logical ports of the 5G system bridge on the device side, and network (NW)-TT ports correspond to logical ports of the 5G system bridge on the network side. The Integration of 3GPP networks into TSN is described further in 3GPP TS 23.501 v.17.0.0 sections 4.4.8, 5.27, 5.28.

The 5GS bridge provides the delay between its logical ports; this information is provided from the TSN AF to the CNC, see 3GPP TS 23.501 section 5.27.5. The delay is set based on pre-configuration in the TSN AF, which sets the delay between the UE and the UPF. Additionally, the TSN AF also considers the UE-DS-TT residence time within the terminal device that is reported to the TSN AF. The pre-configuration is based on the network operator's expected maximum delay that can be provided within the system considering the delay in RAN, and in CN including the delay spent within the transport network between RAN and the UPF.

In release 17, the 5GS architecture was generalized, and the system can also support delay sensitive traffic for IP flows in addition to Ethernet traffic, based on the what the AFs explicitly require. In release 18, 5GS integration with Deterministic Networking (DetNet) for IP was defined. Also, for these additional scenarios, the use of TSN transport helps to fulfill the delay requirements.

In the current system architecture, the transport network that provides connectivity between RAN and CN is considered logically separate from the 3GPP entities, and there is no explicit signalling between the two domains. The transport network can be realized and deployed separately from the 3GPP entities. It is up to the deployment to decide which technology to use in the transport network, which can ensure the required delays within the network. It may be possible to apply a TSN network also in the transport domain, or a DetNet network in the transport domain to make sure that the delay targets are met. However, in the current network architecture there is no control signalling or other ways of an explicit dynamic coordination between the 3GPP entities and the transport domain.

### SUMMARY

As part of developing embodiments herein one or more problems have been identified.

The transport network ensures that delay requirements for the end-to-end delay sensitive flows are met without getting explicit information about the flows themselves. Without the concrete flow information, the transport network may not be able to provide as low delay bounds as it would otherwise be possible. Also, it may be possible that the transport network is able to serve less traffic that meets the delay bounds. The transport network is not able to provide feedback about whether or not a specific flow can be served, and what should be the proper delay bound that the transport network can satisfy.

FIG. 1 shows an architecture according to present.

In order to ensure that delay requirements for the end-to-end delay sensitive flows, the 5GS shall support the separate IP address per quality of service (QoS) flow option. This enables the transport network to identify the flows that require delay sensitive treatment based on the examination of the IP header. This is because typical TSN networks can only use the Ethernet and IP header fields for stream identification, and are not able to look deeper into the packet to use the GPRS tunneling protocol (GTP) tunnel endpoint identifier (TEID) and QoS Flow Identifier (QFI) information in the GTP-user plane (U) headers that would be required based on the existing 3GPP protocol stack. In the current specification, when a protocol data unit (PDU) session is setting up, the transport network tunnel is only one per PDU session. In FIG. 1, it is the step with “Establish RAN tunnel endpoint” between SMF and RAN.

Note that there are also more advanced TSN Ethernet mechanisms that might be used as alternatives. One alternative is to use the so called stream transformation functionality, whereby additional Ethernet encapsulation is added at the RAN or UPF sides to the packets using virtual local area networks (VLAN), and based on the added VLAN headers the QoS flows could be identified. As another alternative, the TSN mask-and-match functionality can also be used to look deeper into the packet and identify the GTP TEID and QFI bits. However, both the stream transformation and the mask-and-match functionality require additional complexity and implementation on the transport network side, and it is expected that these functions would not be available in many practical deployments. Hence the need for the 3GPP network to be able to provide separate IP addresses per QoS flow so that this can be used as the basis of stream identification. The tunnel endpoint IP addresses need to be unique in the network, not only for a given UE. For this, IP version 6 (IPv6) would typically be used to provide the needed address range.

In the current 5G architecture, the PDU session is setup with one GTP-U tunnel (TNL) over NG-U interface. When the interworking with TSN network is deployed in the transport network, for multiple QoS flows within the PDU session, it is not possible to setup the QoS flows into different transport network tunnel over user plane. It is not possible either to ensure that there is a one QoS per F1-U tunnel mapping, in the split NG-RAN architecture.

During handover, the data forwarding is up to the target NG-RAN node to determine if the data forwarding tunnel is per PDU session or per data radio bearer (DRB).

An object of embodiments herein is to improve performance of a UE in a communication network.

According to an aspect the object is achieved, according to some embodiments herein, by providing a method performed by a network node, such as an AMF, an SMF, or a core network node, for handling communication of a UE in a communication network. The network node sets up a separate tunnel for a time sensitive QoS flow. For example, the network node may associate the time sensitive QoS flow with a tunnel such as a GTP-U TNL, e.g., an Uplink transport tunnel.

According to another aspect the object is achieved, according to some embodiments herein, by providing a method performed by a radio network node, such as an gNB, for handling communication in a communication network. The radio network node sets up a separate tunnel for a time sensitive QoS flow. For example, the radio network node may associate the time sensitive QoS flow with a tunnel such as a GTP-U TNL.

It is furthermore provided herein a computer program product comprising instructions, which, when executed on at least one processor, cause the at least one processor to carry out the methods herein, as performed by the radio network node and the network node, respectively. It is additionally provided herein a computer-readable storage medium, having stored thereon a computer program product comprising instructions which, when executed on at least one processor, cause the at least one processor to carry out the method according to the methods herein, as performed by the radio network node and the network node, respectively.

Furthermore, according to another aspect the object is achieved, according to some embodiments herein, by providing a network node and a radio network node configured to perform the methods herein, respectively.

Thus, according to another aspect the object is achieved, according to some embodiments herein, by providing a network node, such as an AMF, an SMF, or a core network node, for handling communication of a UE in a communication network. The network node is configured to set up a separate tunnel for a time sensitive QoS flow.

According to yet another aspect the object is achieved, according to some embodiments herein, by providing a radio network node, such as an gNB, for handling communication in a communication network. The radio network node is configured to set up a separate tunnel for a time sensitive QoS flow.

Embodiments herein support time sensitive traffic flow end-to-end performance including the transport network during setup, modification and handover procedures.

In interworking with TSN network deployed in the transport network, for a time sensitive traffic flow which corresponds to a QoS flow, the radio network node has the option to set up a GTP-U transport tunnel per time sensitive QoS flow, and a GTP-U tunnel per redundant time sensitive QoS flow in order to enable the identification of the flows in the TSN transport network based on, e.g., an end-address such as a GTP tunnel endpoint IP address.

In the split architecture, the entity which terminates the GTP-U transport tunnels may set up one GTP-U tunnel per QoS flow. Between gNB-centralized unit (CU) and gNB-distributed unit (DU), the transport tunnel may be per DRB. It is specified that when the QoS flow is for time sensitive traffic flow, it may require to set up one DRB/QoS flow, in order to ensure the end-to-end low latency performance archived by interworking with TSN network.

During handover, the source NG-RAN node may indicate the requirement of setting GTP-U TNL/QoS flow. The target NG-RAN node may thus be specified to set up the handling of time sensitive QoS flows accordingly.

For data forwarding, the TSN QoS flows may perform data forwarding per DRB, and not per PDU session. It is further herein disclosed how to, in dual connectivity, handle the split bearer.

The time sensitive QoS flows may be grouped into a separate GTP tunnel, and the transport network may use a QFI to identify the individual flows.

It may further be possible to aggregate the QoS flows for the different UEs in case they have the same periodicity and their burst times match each other.

Embodiments herein provide one or more of the following advantages:
Interwork with TSN network deployed in the transport network can be supported by the radio network node.
During time sensitive QoS flow handover, the data forwarding is performed with the support of the TSN transport network characteristics.

This will thus result in an improved performance at a UE using a time sensitive application in the communication network.

### BRIEF DESCRIPTION OF THE DRAWINGS

Embodiments will now be described in more detail in relation to the enclosed drawings, in which:

FIG. 1 shows an overview depicting a communication network;

FIG. 2 shows an overview depicting a communication network according to embodiments herein;

FIG. 3 shows a flowchart illustrating a method performed by a network node according to embodiments herein;

FIG. 4 shows a flowchart illustrating a method performed by a radio network node according to embodiments herein;

FIG. 5 shows a block diagram depicting embodiments of a network node according to embodiments herein;

FIG. 6 shows a block diagram depicting embodiments of a radio network node according to embodiments herein;

FIG. 7 schematically illustrates a telecommunication network connected via an intermediate network to a host computer;

FIG. 8 is a generalized block diagram of a host computer communicating via a base station with a user equipment over a partially wireless connection; and

FIGS. 9, 10, 11, and 12 are flowcharts illustrating methods implemented in a communication system including a host computer, a base station and a user equipment.

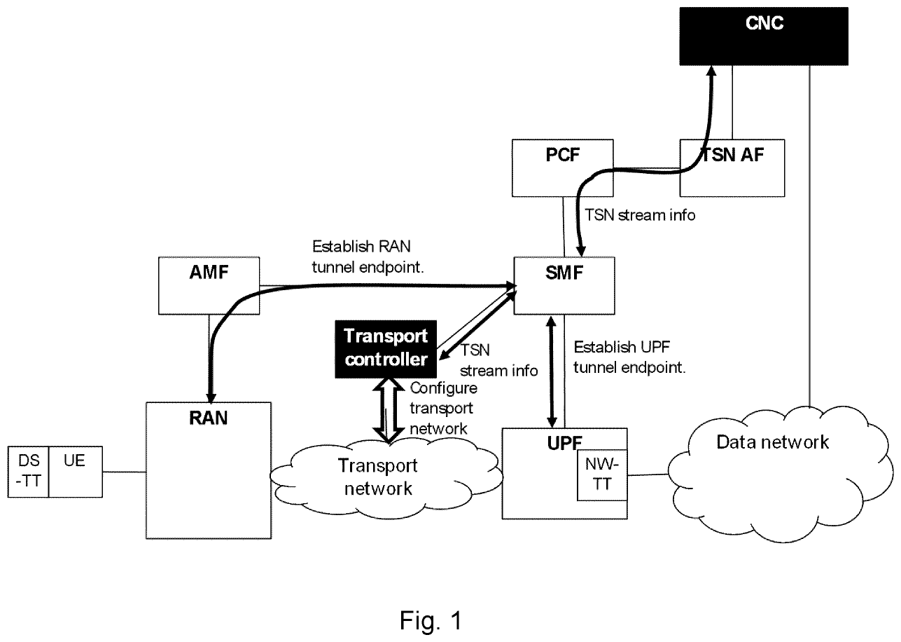

### DETAILED DESCRIPTION

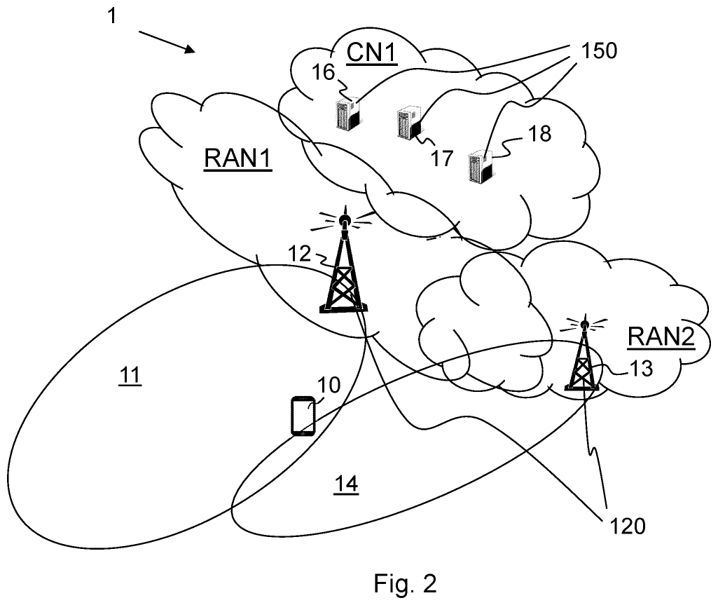

Embodiments herein relate to communication networks in general. FIG. 2 is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first radio access technology (RAT), such as NR, LTE, or similar. The first radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the first radio network node 12 depending e.g. on the first radio access technology and terminology used. The first radio network node may be referred to as a master node (MN) in case of dual connectivity, or a serving radio network node wherein the service area may be referred to as a serving cell, and the serving network node communicates with the UE 10 in form of DL transmissions to the UE 10 and UL transmissions from the UE 10. It should be noted that a service area may be denoted as cell, beam, beam group or similar to define an area of radio coverage. The first radio network node 12 may be a source node or serving node.

The communication network 1 comprises a second radio network node 13 or just radio network node, providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the first radio access technology and terminology used. The second radio network node may be referred to as a secondary node (SN) in case of dual connectivity, a visiting radio network node or target radio network node, wherein the service area may be referred to as a visiting cell or target cell, and the second network node communicates with the UE in form of DL transmissions to the UE and UL transmissions from the UE. It should be noted that a service area may be denoted as cell, beam, beam group or similar to define an area of radio coverage. The second radio network node 13 may be a target node or candidate node.

The first RAT may be the same RAT as the second RAT or the first RAT may be a different RAT than the second RAT.

The communication network 1 may further comprise a number of network nodes 150 such as core network nodes providing, e.g. in NR, network functions (NF) or actually instantiations of NFs also referred to as NF instances, such as a first network node 16 providing, for example, an instantiation of an AMF, a second network node 17 providing an instantiation of a SMF, and a third network node 18 providing, for example, an instantiation of an PCF, or any other NF instances in the communication network 1. The different NF instances may have different tasks. Other functions may be for LTE such as mobility management entity (MME) or similar.

The respective node may be a standalone server, a cloud-implemented server, a distributed server or processing resources in a server farm or same node. Embodiments herein may be implemented as physical bare metal, virtual or cloud native such as Kubernetes environment in e.g. hyper-cloud networks.

According to embodiments herein a radio network node 120, such as the first radio network node 12 and/or the second radio network node 13, may handle QoS flows in an efficient manner. The radio network node 120 and the network node 150 set up a separate tunnel for a time sensitive QoS flow.

Interworking with TSN network deployed in the transport network, for a time sensitive traffic flow which corresponding to a QoS flow, the radio network node 120, such as a NG-RAN node, may set up a GTP-U transport tunnel per time sensitive QoS flow, and a GTP-U tunnel per redundant time sensitive QoS flow in order to enable the identification of the flows in the TSN transport network based on a GTP tunnel endpoint IP address.

In the split architecture, the entity, such as the radio network node 120 or the network node 150, which terminates the GTP-U transport tunnels may set up one GTP-U tunnel per QoS flow. Between a gNB-CU and a gNB-DU, the transport tunnel may be per DRB. It may be specified that when the QoS flow is a time sensitive traffic flow, it requires setting up one DRB/QoS flow, in order to ensure the end-to-end low latency performance archived by interworking with TSN network.

During handover, the first radio network node 12, such as a source NG-RAN node, may indicate the requirement of setting GTP-U TNL/QoS flow. The second radio network node 13, such as a target NG-RAN node, may be specified to set up the handling of time sensitive QoS flows accordingly.

For data forwarding, it may be specified that the TSN QoS flows perform data forwarding per DRB, not per PDU session.

It is herein specified how to, in dual connectivity, handle the split bearer.

The time sensitive QoS flows may be grouped into a separate GTP tunnel. The transport network may use the QFI to identify the individual flows.

It may further be possible to aggregate the flows for different UEs in case they have the same periodicity and their burst times match each other.

Embodiments herein provide one or more of the following advantages:
Interwork with TSN network deployed in the transport network can be supported by the radio network node 120 such as a NG-RAN node.
During time sensitive QoS flow handover, the data forwarding may be performed with the support of the TSN transport network characteristics.

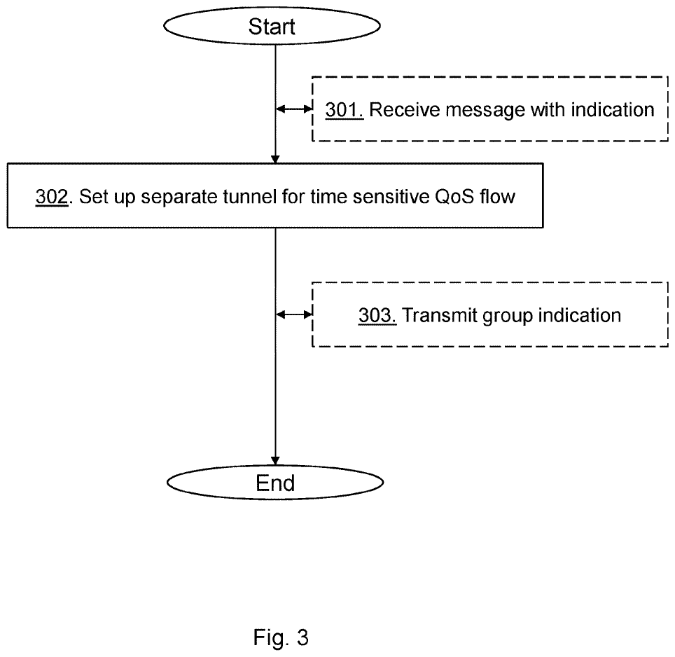

The method actions performed by the network node 150, such as the AMF or SMF, for handling communication in the communication network, for example, handling a time sensitive QoS flow, according to embodiments herein will now be described with reference to a flowchart depicted in FIG. 3. The actions do not have to be taken in the order stated below, but may be taken in any suitable order. Actions performed in some embodiments are marked with dashed boxes.

Action 301. The network node 150 may receive a message from the radio network node 120 with an indication. The indication may indicate support of setting up time sensitive QoS flows for separate tunnels. The indication may be sent during NG setup procedure, or via UE context setup procedure for a PDU session.

Action 302. The network node 150 sets up a separate tunnel for a time sensitive QoS flow. For example, the network node 150 may associate or set up the time sensitive QoS flow with the tunnel such as the Uplink transport tunnel. As an example, the network node 150 may allocate a GTP-U TNL per time sensitive QoS flow in a PDU session. The network node 150 may thus associate a QoS flow with a GTP-U TNL. The network node 150 may allocate the Uplink transport TNL per time sensitive QoS flow in the PDU session.

The PDU session may contain one time sensitive QoS flow and one or more non-time sensitive QoS flows, then the separate tunnel may be used for the time sensitive QoS flow, of the PDU session, and another tunnel is setup for the one or more non-time sensitive QoS flows. Thus, when a PDU session contains only one QoS flow and that QoS flow is time sensitive traffic flow, the tunnel may be used for the time sensitive QoS flow. When additional, non-time sensitive QoS flows are added to the PDU session, a new tunnel may be setup for the non-time sensitive QoS flows and may be swapped to the PDU session tunnel. The previously setup PDU session tunnel used by the time sensitive QoS flow may be continued as the TNL for the indicated time sensitive QoS.

Alternatively, when the PDU session contains only one QoS flow and that QoS flow is time sensitive traffic flow, the PDU session tunnel may be used for the time sensitive QoS flow. When additional, non-time sensitive QoS flows are added to the PDU session, a new TNL may be set-up for the existing time sensitive QoS flow.

Some legacy Ultra-reliable and low-latency communication (URLLC) functions, e.g. redundant QoS flow over NG-U for the time sensitive traffic flow may not be supported to avoid potential complexity.

The network node 150 may group time sensitive QoS flows with a latency requirement within a set interval, and the group of QoS Flows is using the same tunnel. Thus, the network node 150 may group time sensitive QoS flows with a same (or similar, i.e., within a set interval) latency requirement. The group of QoS Flows may be using the same tunnel.

Action 303. The network node 150 may transmit to the radio network node 120, a group indication of the grouped QoS flows. The radio network node 120 may set up the grouped QoS flows in one DRB.

The network node 150 may group the time sensitive QoS flows with the same or similar latency requirement for different UEs. The network node 150 may inform the radio network node 120 of the grouping with the group indication.

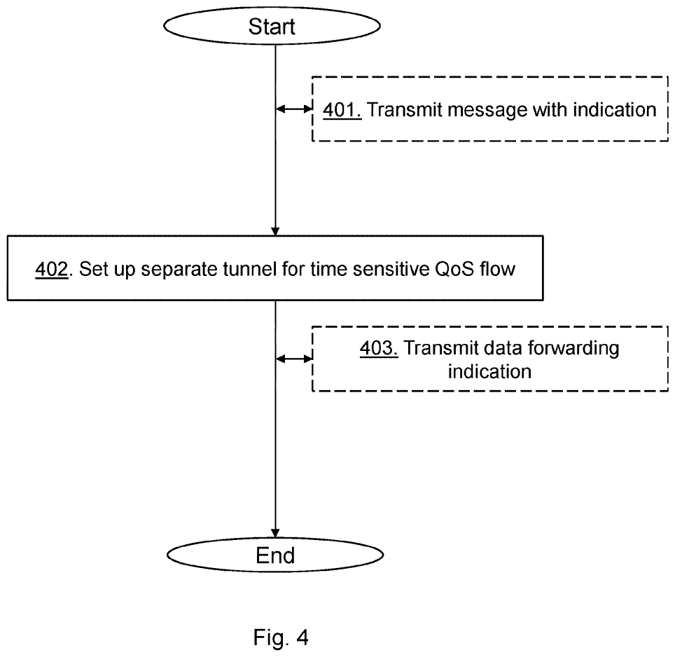

The method actions performed by the radio network node 120, such as the first radio network node 12 or second radio network node 13, for handling communication of the UE 10 in the communication network 1, for example, handling a time sensitive QoS flow, according to embodiments herein will now be described with reference to a flowchart depicted in FIG. 4. The actions do not have to be taken in the order stated below, but may be taken in any suitable order. Actions performed in some embodiments are marked with dashed boxes.

Action 401. The radio network node 120 may transmit the message to the network node 150 with the indication. The indication may indicate support of setting up time sensitive QoS flows for separate tunnels. The indication may be sent during NG setup procedure, or via UE context setup procedure for a PDU session.

Action 402. The radio network node 120 sets up the separate tunnel for the time sensitive QoS flow. For example, the radio network node 120 may set up or associate each time sensitive QoS flow with a separate tunnel.

The radio network node 120 may receive from the network node 150, the group indication of grouped QoS flows in a separate tunnel. The radio network node 120 may then set up the grouped QS flows in one DRB. In the split NG-RAN architecture of dual connectivity (DC), one F1-U tunnel may be set up for the grouped time sensitive QoS flows. The network node 150 may group the time sensitive QoS flows with the same or similar latency requirement for different UEs.

A Multicast and Broadcast Service (MBS) function may be used to distribute the content mapped on these flows to the UEs.

During handover from the first radio network node 12 to the second radio network node 13, the time sensitive QoS flows may be indicated from the first radio network node 12 to the second radio network node 13. The second radio network node 13 may then act accordingly, and the second radio network node 13 may cancel the handover when the requirement cannot be fulfilled, i.e., cannot setup separate tunnel for the time sensitive QoS flow.

Action 403. Data forwarding may only be allowed per DRB level for time sensitive QoS. The first radio network node 12 may transmit a data forwarding indication that data is forwarded for the time sensitive QoS flow. The data forwarding indication may comprise one or more parameters associated to the QoS, or by indication in the Data Forwarding QoS.

In DC, the first radio network node 12, such as a master node (MN), may transmit to the second radio network node 13, such as a secondary node (SN), that the QoS is time sensitive and requires a tunnel to be setup per QoS flow. For the split bearer, it is indicated, with an indication, that the time sensitive QoS should be mapped to DRB per QoS.

Herein, the time sensitive traffic flow that is corresponding to a QoS flow is referred to as “time sensitive QoS flow”. An indication may comprise a value, an index, a real value or text.

### Examples of Core Network Embodiments:

In one embodiment, the radio network node 120 indicates to the network node 150 if it supports an AN-TL function and how it will support the AN-TL function. The network node 150 may act accordingly during QoS setup. The implementation could be an indication in NG setup procedure, or via UE context setup procedure.

In another embodiment, the network node 150 allocates the Uplink transport TNL per time sensitive QoS flow in the PDU session.

Below are examples of information elements (IE) described.

TS 38.413 v. 17.3.0 section 9.3.4.1 PDU Session Resource Setup Request Transfer

This IE is transparent to the AMF.

| | | | | | | |
|---|---|---|---|---|---|---|
| | | | IE type | | | |
| | | | and | Semantics | | Assigned |
| IE/Group Name | Presence | Range | reference | description | Criticality | Criticality |

| | | | | |
|---|---|---|---|---|
| PDU Session | O | 9.3.1.102 | YES | reject |
| Aggregate | | | | |
| Maximum Bit | | | | |
| Rate | | | | |
| UL NG-U UP | M | | YES | reject |
| TNL Information | | | | |

Skip the unrelated IEs

| | | | | | | |
|---|---|---|---|---|---|---|
| QoS Flow | | 1 | | | YES | reject |
| Setup Request | | | | | | |
| List | | | | | | |
| >QoS Flow | | 1 . . . <maxnoofQoSFlows> | | | — | |
| Setup Request | | | | | | |
| Item | | | | | | |
| >>QoS Flow | M | | 9.3.1.51 | | — | |
| Identifier | | | | | | |
| >>QoS Flow | M | | 9.3.1.12 | | — | |
| Level QoS | | | | | | |
| Parameters | | | | | | |
| >>E-RAB ID | O | | 9.3.2.3 | | — | |
| >>TSC Traffic | O | | 9.3.1.130 | This IE may | YES | ignore |
| Characteristics | | | | be present in | | |
| | | | | case of GBR | | |
| | | | | QoS flows | | |
| | | | | and is | | |
| | | | | ignored | | |
| | | | | otherwise. | | |
| >>Redundant | O | | 9.3.1.134 | This IE | YES | ignore |
| QoS Flow | | | | indicates | | |
| Indicator | | | | whether this | | |
| | | | | QoS flow is | | |
| | | | | requested for | | |
| | | | | the | | |
| | | | | redundant | | |
| | | | | transmission. | | |
| >>>Redundant | O | | UP | endpoint of | YES | reject |
| QoS NG-U UP | | | Transport | the NG-U | | |
| TNL | | | Layer | transport | | |
| Information | | | Information | bearer for | | |
| | | | 9.3.2.2 | redundant | | |
| | | | | time | | |
| | | | | sensitive | | |
| | | | | QoS flow | | |
| >> NG-U UP | O | | UP | endpoint of | YES | reject |
| TNL | | | Transport | the NG-U | | |
| Information | | | Layer | transport | | |
| | | | Information | bearer for | | |
| | | | 9.3.2.2 | time | | |
| | | | | sensitive | | |
| | | | | QoS flow | | |

Skip the unrelated IEs

This is an example to include GTP-U tunnel per time sensitive QoS flow in PDU session setup request (being underlined). The IEs are denoted as Redundant QoS NG-U UP TNL information and NG-U UP TNL information specified in PDU session Resource setup request transfer.

A more general solution is to associate a QoS flow with a GTP-U TNL.

TS 38.413 v. 17.3.0 section 9.3.1.51 QoS Flow Identifier

This IE identifies a QoS flow within a PDU Session, or a MBS QoS flow within a MBS session.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| QoS Flow | M | INTEGER | | — | |
| Identifier | | (0 . . . 63, . . . ) | | | |
| NG-U UP TNL | O | UP Transport | endpoint of the | YES | reject |
| Information | | Layer | NG-U transport | | |
| | | Information | bearer for time | | |
| | | 9.3.2.2 | sensitive QoS flow. | | |

This is an example, underlined, to implement setting up GTP-U tunnel per QoS flow by including the NG-U UP TNL information in QoS Flow Identifier IE. The QoS flow identifier from TS 38.413 v.17.3.0 section 9.3.1.51 is an IE that identifies a QoS flow within a PDU session or an MBS QoS flow within an MBS session. The definition and use of the QoS flow identifier is specified in TS 23.501 v.17.7.0.

This is an example, underlined, to implement setting up GTP-U tunnel per QoS flow using NG-U UP TNL information. TS 38.413 v. 17.7.0 section 9.3.1.134 Redundant QoS Flow Indicator

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Redundant | M | ENUMERATED | | — | |
| QoS Flow | | (true, false) | | | |
| Indicator | | | | | |
| NG-U UP TNL | O | UP Transport | endpoint of the | YES | reject |
| Information | | Layer | NG-U transport | | |
| | | Information | bearer for time | | |
| | | 9.3.2.2 | sensitive QoS | | |
| | | | flow. | | |

The redundant QoS flow indicator from TS 38.413 v. 17.3.0 section 9.3.1.134 is an IE that provides the redundant QoS indicator for a QoS flow as specified in TS 23.501 v. 17.7.0.

In another embodiment, when the PDU session contains only one QoS flow and that QoS flow is time sensitive traffic flow, the PDU session TNL is used for the time sensitive QoS flow. When additional, non-time sensitive QoS flows are added to the PDU session, a new TNL is setup for the non-time sensitive QoS flows and is swapped to the PDU session TNL. The previously setup PDU session TNL used by the time sensitive QoS flow is continued as the TNL for the indicated time sensitive QoS.

In another embodiment, when the PDU session contains only one QoS flow and that QoS flow is time sensitive traffic flow, the PDU session TNL is used for the time sensitive QoS flow. When additional, non-time sensitive QoS flows are added to the PDU session, a new TNL is setup for the existing time sensitive QoS flow.

In another embodiment, it is specified that some legacy URLLC functions, e.g. redundant QoS flow over NG-U for the time sensitive traffic flow is not supported to avoid potential complexity.

### Examples of the RAN Side Embodiments:

In one embodiment, for each accepted time sensitive QoS flow, a separate TNL is setup.

TS 38.413 v. 17.7.0 section 9.3.4.2 PDU Session Resource Setup Response Transfer

This IE is transparent to the AMF.

| | | | | | | |
|---|---|---|---|---|---|---|
| IE/Group | | | IE type and | Semantics | | Assigned |
| Name | Presence | Range | reference | description | Criticality | Criticality |

| | | | |
|---|---|---|---|
| DL QoS Flow | M | QoS Flow | — |
| per TNL | | per TNL | |
| Information | | Information | |
| | | 9.3.2.8 | |

Skip the unchanged IEs

| | | | | | | |
|---|---|---|---|---|---|---|
| MBS Session | O | | 9.3.1.214 | | YES | ignore |
| Failed to | | | | | | |
| Setup List | | | | | | |
| time | | 0 | | | YES | reject |
| sensitive | | | | | | |
| QoS flow | | | | | | |
| Setup | | | | | | |
| Response | | | | | | |
| List | | | | | | |
| >QoS Flow | | 1 . . . <maxnoofQoSFlows> | | | — | |
| Item | | | | | | |
| >>QoS Flow | M | | 9.3.1.51 | | — | |
| Identifier | | | | | | |
| >>NG-U UP | M | | 9.3.1.12 | | — | |
| TNL | | | | | | |
| Information | | | | | | |
| >>Redundant | M | | 9.3.1.12 | Used if the | — | |
| NG-U UP | | | | QoS flow is | | |
| TNL | | | | redundant | | |
| Information | | | | | | |

This is an example, underlined, to implement setting up GTP-U tunnel per Time sensitive QoS flow. In TS 38.413 v.17.3.0 section 9.3.4.2 the IE PDU session Resource setup response transfer is disclosed. The IE may comprise Time sensitive QoS flow Setup Response List information.

In another embodiment, it is specified that when the QoS flow is time sensitive traffic flow, it requires setting up one DRB/QoS flow. An example to specify setting up one DRB per time sensitive QoS flow: In TS 38.300 section 16 for URLLC, 16.x Support of TSN AN-TL. For each time sensitive QoS flow, NG-RAN node may set up individual DRB in order to support end-to-end interworking with TSN transport network in NG-RAN node.

In another embodiment, during Xn or NG handover, the time sensitive QoS flows are indicated from the first radio network node 12 such as a source NG-RAN node to the second radio network node 13 such as a target NG-RAN node. The second radio network node 13 may act accordingly, and the first radio network node 12 may cancel the handover when the requirement cannot be fulfilled.

In another embodiment, it is specified that the data forwarding is only allowed per DRB level for time sensitive QoS. refer to data forwarding below. The second radio network node 13 may be made aware of the time sensitive QoS flow data forwarding either by parameters associated to the QoS, or by indication in the Data Forwarding QoS.

In another embodiment in Dual connectivity, the first radio network node 12 such as a master node, indicates to the second radio network node 13 such as a secondary node, that the QoS is TSN and requires GTP-U tunnel to be setup per QoS flow. For the split bearer, it is specified that the time sensitive QoS should be mapped to DRB per QoS.

### Grouping Time Sensitive QoS Flows.

In one embodiment, the network node 150 groups the time sensitive QoS flows with the same or similar latency requirement. The group of QoS Flows are using the same GTP-U tunnel, and in the radio network node 120 such as a NG-RAN node, are set up in one DRB. The radio network node 120 may be made aware of the grouping to ensure, in the split NG-RAN architecture, one F1-U tunnel is set up for the grouped time sensitive QoS flows.

In another embodiments, the network node 150 groups the time sensitive QoS flows with the same or similar latency requirement for different UEs. MBS like function may be used to distribute the content mapped on these flows to the UEs.

The data forwarding may be exemplified in TS 38.300 9.2.3.2.3 Data Forwarding

The following description depicts the data forwarding principles for intra-system handover.

The source NG-RAN node may suggest downlink data forwarding per QoS flow established for a PDU session and may provide information how it maps QoS flows to DRBs. The target NG-RAN node decides data forwarding per QoS flow established for a PDU Session.

If “the time sensitive QoS handover” is required and separate GTP tunnel is needed for stream identification in the transport network, the source NG-RAN node should only suggest the data forwarding per DRB. The target NG-RAN node should only apply data forwarding per DRB by establishing a forwarding tunnel for the DRB.

If “lossless handover” is required and the QoS flows to DRB mapping applied at the target NG-RAN node allows applying for data forwarding the same QoS flows to DRB mapping as applied at the source NG-RAN node for a DRB and if all QoS flows mapped to that DRB are accepted for data forwarding, the target NG-RAN node establishes a downlink forwarding tunnel for that DRB.

For a DRB for which preservation of SN status applies, the target NG-RAN node may decide to establish an UL data forwarding tunnel.

The target NG-RAN node may also decide to establish a downlink forwarding tunnel for each PDU session. Thus, upon the reception of the TSN QoS flow (or grouped TSN QoS flow) tunnel, the radio network node 120 may respond to Core Network with the separate Uplink GTP-U tunnel, and associate the (these) TSN QoS flows with a DRB-.

In this case the target NG-RAN node provides information for which QoS flows data forwarding has been accepted and corresponding UP TNL information for data forwarding tunnels to be established between the source NG-RAN node and the target NG-RAN node.

If QoS flows have been re-mapped at the source NG-RAN node and user packets along the old source mapping are still being processed at handover preparation, and if the source NG-RAN node has not yet received the SDAP end marker for certain QoS flows when providing the SN status to the target NG-RAN node, the source NG-RAN node provides the old side QoS mapping information for UL QoS flows to the target NG-RAN node for which no SDAP end marker was yet received. The target NG-RAN will receive for those QoS flows the end marker when the UE finalises to send UL user data according to the old source side mapping.

The source NG-RAN node may also propose to establish uplink forwarding tunnels for some PDU sessions in order to transfer SDAP SDUs corresponding to QoS flows for which flow re-mapping happened before the handover and the SDAP end marker has not yet been received, and for which user data was received at the source NG-RAN node via the DRB to which the QoS flow was remapped. If accepted the target NG-RAN node shall provide the corresponding UP TNL information for data forwarding tunnels to be established between the source NG-RAN node and the target NG-RAN node.

This is an example to specify that for each time sensitive QoS flow, the data forwarding shall only be performed per DRB (i.e. per QoS)

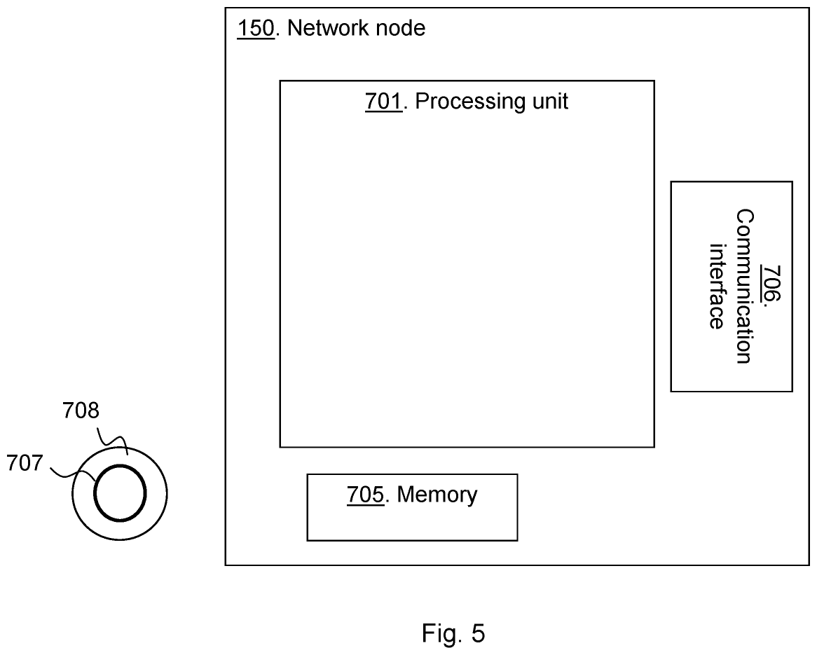

FIG. 5 is a block diagram depicting the network node 150, such as an AMF or an SMF or core network node, for handling communication of the UE 10 in the communication network 1, for example, handling a time sensitive QoS flow, according to embodiments herein.

The network node 150 may comprise processing circuitry 701, e.g. one or more processors, configured to perform the methods herein.

The network node 150 and/or the processing circuitry 701 is configured to set up the separate tunnel for the time sensitive QoS flow. For example, the network node 150 and/or the processing circuitry 701 may be configured to associate or set up a time sensitive QoS flow with a tunnel such as an Uplink transport tunnel e.g., a GTP-U tunnel.

The network node 150 and/or the processing circuitry 701 may be configured to receive a message from the radio network node 120 with the indication. The indication indicates support of setting up time sensitive QoS flows for separate tunnels. The indication may be sent during NG setup procedure, or via UE context setup procedure for a PDU session.

The network node 150 and/or the processing circuitry 701 may be configured to allocate the Uplink transport tunnel per time sensitive QoS flow in the PDU session. The network node 150 and/or the processing circuitry 701 may be configured to allocate a GTP-U TNL per time sensitive QoS flow in a PDU session. The network node and/or the processing circuitry 701 may be configured to associate a QoS flow with a GTP-U TNL.

The PDU session may contain one time sensitive QoS flow and one or more non-time sensitive QoS flows, then the separate tunnel may be used for the time sensitive QoS flow, of the PDU session, and another tunnel is setup for the one or more non-time sensitive QoS flows. Thus, when a PDU session contains only one QoS flow and that QoS flow is time sensitive traffic flow, the tunnel may be used for the time sensitive QoS flow. When additional, non-time sensitive QoS flows are added to the PDU session, a new tunnel may be setup for the non-time sensitive QoS flows and may be swapped to the PDU session tunnel. The previously setup PDU session tunnel used by the time sensitive QoS flow may be continued as the TNL for the indicated time sensitive QoS.

Alternatively, when the PDU session contains only one QoS flow and that QoS flow is time sensitive traffic flow, the PDU session tunnel may be used for the time sensitive QoS flow. When additional, non-time sensitive QoS flows are added to the PDU session, a new TNL may be setup for the existing time sensitive QoS flow.

Some legacy URLLC functions, e.g. redundant QoS flow over NG-U for the time sensitive traffic flow may not be supported to avoid potential complexity.

The network node 150 and/or the processing circuitry 701 may be configured to group time sensitive QoS flows with a latency requirement within a set interval, and the group of QoS Flows are using the same tunnel. Thus, the network node and/or the processing circuitry 701 may be configured to group time sensitive QoS flows with a same (or similar, i.e., within a set interval) latency requirement. The group of QoS Flows may be using the same tunnel.

The network node 150 and/or the processing circuitry 701 may be configured to transmit to the radio network node 120, a group indication of the grouped QoS flows, and the radio network node 120 may set up the grouped QoS flows in one DRB.

The network node 150 and/or the processing circuitry 701 may be configured to group the time sensitive QoS flows with the same or similar latency requirement for different UEs. The network node and/or the processing circuitry 701 may be configured to inform the radio network node 120 of the grouping with the group indication.

The network node 150 may comprise a memory 705. The memory 705 comprises one or more units to be used to store data on, such as data packets, indications of support, indications, associated time sensitive QoS flow with respective tunnel, events and applications to perform the methods disclosed herein when being executed, and similar. Furthermore, the network node 150 may comprise a communication interface 706 such as comprising a transmitter, a receiver, a transceiver and/or one or more antennas.

The methods according to the embodiments described herein for the network node 150 are respectively implemented by means of e.g. a computer program product 707 or a computer program, comprising instructions, i.e., software code portions, which, when executed on at least one processor, cause the at least one processor to carry out the actions described herein, as performed by the network node 150. The computer program product 707 may be stored on a computer-readable storage medium 708, e.g., a disc, a universal serial bus (USB) stick or similar. The computer-readable storage medium 708, having stored thereon the computer program product, may comprise the instructions which, when executed on at least one processor, cause the at least one processor to carry out the actions described herein, as performed by the network node 150. In some embodiments, the computer-readable storage medium may be a transitory or a non-transitory computer-readable storage medium. Thus, embodiments herein may disclose the network node for handling communication of the UE in a communication network, wherein the network node comprises processing circuitry and a memory, said memory comprising instructions executable by said processing circuitry whereby said network node is operative to perform any of the methods herein.

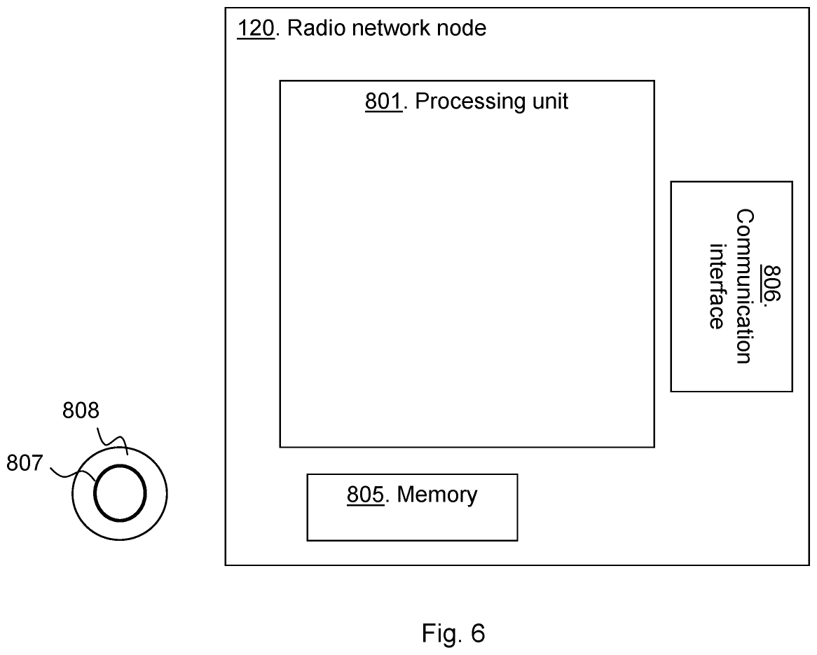

FIG. 6 is a block diagram depicting the radio network node 120, such as the first radio network node 12 or the second radio network node 13, for handling communication of the UE 10 in the communication network 1, for example, handling a time sensitive QoS flow, according to embodiments herein.

The radio network node 120 may comprise processing circuitry 801, e.g. one or more processors, configured to perform the methods herein.

The radio network node 120 and/or the processing circuitry 801 is configured to set up the separate tunnel for the time sensitive QoS flow. For example, the radio network node and/or the processing circuitry 801 may be configured to set up or associate each time sensitive QoS flow with a separate tunnel.

The radio network node 120 and/or the processing circuitry 801 may be configured to transmit the message to the network node with the indication. The indication indicates support of setting up time sensitive QoS flows for separate tunnels. The indication may be sent during NG setup procedure, or via UE context setup procedure for a PDU session.

The radio network node 120 and/or the processing circuitry 801 may be configured to receive from the network node 150, the group indication of grouped QoS flows in a separate tunnel. The radio network node 120 and/or the processing circuitry 801 may be configured to set up the grouped QoS flows in one DRB. In the split NG-RAN architecture of DC, one F1-U tunnel is setup for the grouped time sensitive QoS flows. The radio network node 120 and/or the processing circuitry 801 may be configured to group the time sensitive QoS flows with the same or similar latency requirement for different UEs.

The radio network node 120 and/or the processing circuitry 801 may be configured to use a MBS function to distribute the content mapped on these flows to the UEs.

During handover from the first radio network node 12 to the second radio network node 13, the time sensitive QoS flows may be indicated from the first radio network node 12 to the second radio network node 13. The radio network node 120 and/or the processing circuitry 801 may be configured to act accordingly. The radio network node 120 and/or the processing circuitry 801 may be configured to cancel the handover when the requirement cannot be fulfilled, i.e., cannot setup separate tunnel for the time sensitive QoS flow.

Data forwarding may only be allowed per DRB level for time sensitive QoS. The radio network node 120 and/or the processing circuitry 801 may be configured to transmit the data forwarding indication that data is forwarded for the time sensitive QoS flow. The data forwarding indication may comprise one or more parameters associated to the QoS, or by indication in the Data Forwarding QoS.

In DC, the radio network node 120 and/or the processing circuitry 801 may be configured to transmit to the second radio network node 13 (secondary node (SN)) that the QoS is time sensitive and requires a to be setup per QoS flow. For the split bearer, it is indicated, with an indication, that the time sensitive QoS should be mapped to DRB per QoS.

The radio network node 120 may comprise a memory 805. The memory 805 comprises one or more units to be used to store data on, such as data packets, indications of support, further indications, information, events and applications to perform the methods disclosed herein when being executed, and similar. Furthermore, the radio network node 120 may comprise a communication interface 806 such as comprising a transmitter, a receiver, a transceiver and/or one or more antennas.

The methods according to the embodiments described herein for the radio network node 120 are respectively implemented by means of e.g. a computer program product 807 or a computer program, comprising instructions, i.e., software code portions, which, when executed on at least one processor, cause the at least one processor to carry out the actions described herein, as performed by the radio network node 120. The computer program product 807 may be stored on a computer-readable storage medium 808, e.g., a disc, a USB stick or similar. The computer-readable storage medium 808, having stored thereon the computer program product, may comprise the instructions which, when executed on at least one processor, cause the at least one processor to carry out the actions described herein, as performed by the radio network node 120. In some embodiments, the computer-readable storage medium may be a transitory or a non-transitory computer-readable storage medium. Thus, embodiments herein may disclose the radio network node for handling communication of the UE in a communication network, wherein the radio network node comprises processing circuitry and a memory, said memory comprising instructions executable by said processing circuitry whereby said radio network node is operative to perform any of the methods herein.

In some embodiments a more general term “network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

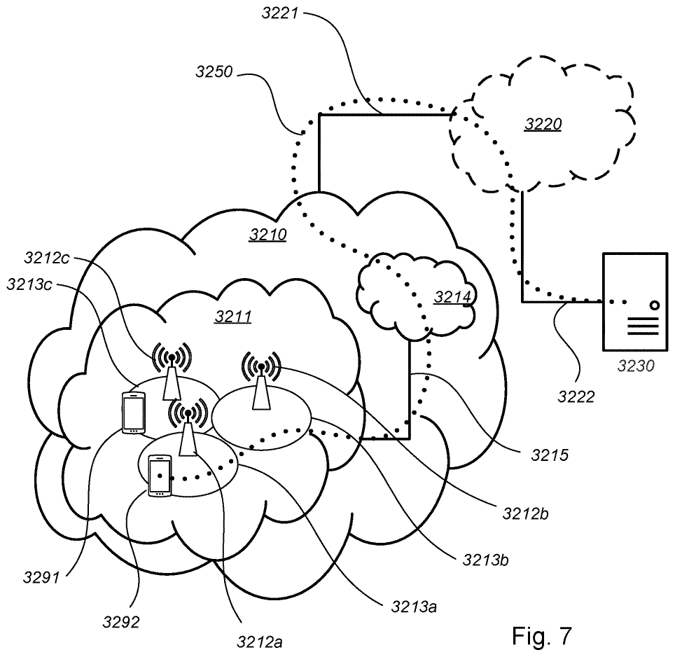

With reference to FIG. 7, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE), such as by connecting UEs (one or more of which may be generally referred to as UEs 3291, 3292) to the core network over one or more wireless connections.

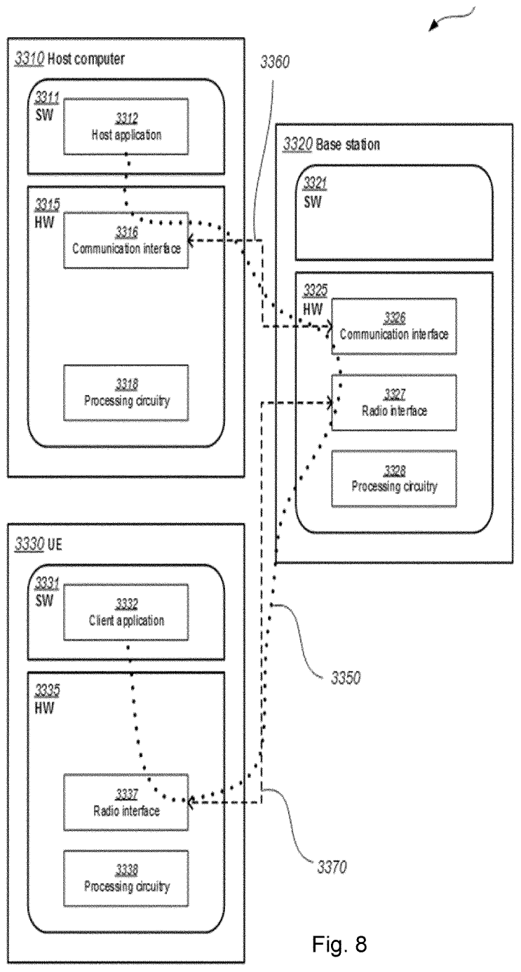

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since time sensitive traffic may handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

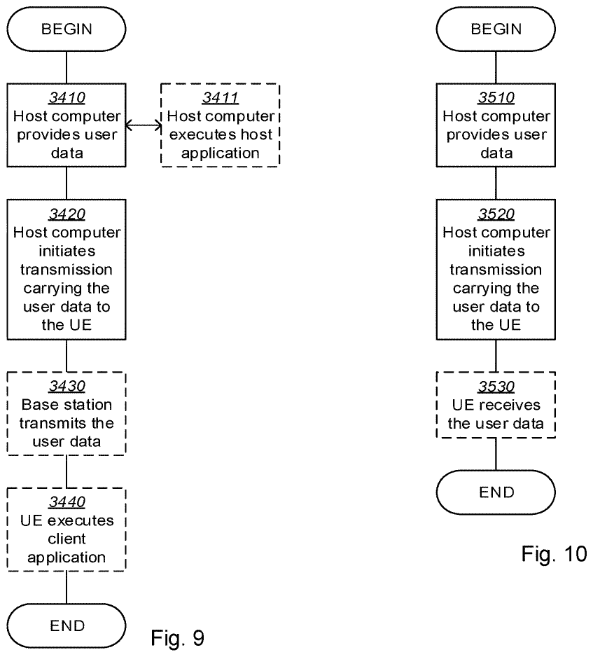

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

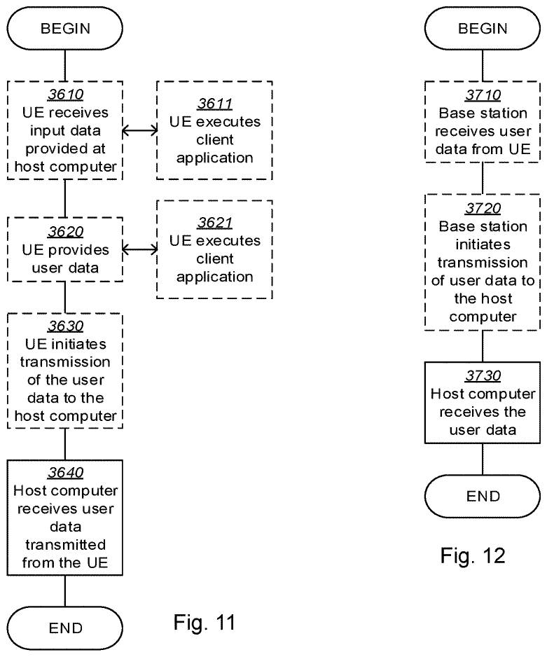

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

| Abbreviation | Explanation |
|---|---|
| CN | Core Network |
| AMF | Access and Mobility Management Function |
| CP | Control Plane |
| CU | Central Unit |
| CU-CP | Central Unit Control Plane |
| CU-UP | Central Unit User Plane |
| UE AMBR | UE Aggregate Maximum Bit Rate |
| TSN | Time-Sensitive Networking |
| TSCAI | Time Sensitive Communication Assistance Information |
| AF | Application Function |

1-28. (canceled)

29. A method performed by a network node for handling communication in a communication network, the method comprising:
setting up a separate tunnel for a time sensitive quality of service (QoS) flow.

30. The method according to claim 29, wherein setting up the separate tunnel comprises associating the time sensitive QoS flow with an uplink transport tunnel.

31. The method according to claim 29, comprising receiving a message from a radio network node with an indication, wherein the indication indicates support of setting up time sensitive QoS flows for separate tunnels.

32. The method according to claim 29, wherein setting up the separate tunnel for the time sensitive QoS flow comprises allocating a GPRS tunneling protocol-user plane tunnel (GTP-U TNL) per time sensitive QoS flow in a protocol data unit (PDU) session.

33. The method according to claim 29, when a protocol data unit (PDU) session contains one time sensitive QoS flow and one or more non-time sensitive QoS flows, the separate tunnel is used for the time sensitive QoS flow of the PDU session and another tunnel is setup for the one or more non-time sensitive QoS flows.

34. The method according to claim 29, wherein setting up the separate tunnel comprises grouping time sensitive QoS flows with a latency requirement within a set interval, and the group of QoS Flows use the same tunnel.

35. The method according to claim 34, comprising transmitting to a radio network node a group indication of the grouped QoS flows.

36. A method performed by a radio network node for handling communication of a user equipment (UE) in a communication network, the method comprising:
setting up a separate tunnel for a time sensitive quality of service (QoS) flow.

37. The method according to claim 36, wherein setting up the separate tunnel comprises associating the time sensitive QoS flow with an uplink transport tunnel.

38. The method according to claim 36, comprising transmitting a message to a network node with an indication, wherein the indication indicates support of setting up time sensitive QoS flows for separate tunnels.

39. The method according to claim 36, comprising:
receiving from a network node, a group indication of grouped QoS flows in a separate tunnel; and
setting up the grouped QoS flows in one data radio bearer (DRB).

40. The method according to claim 36, comprising, during handover from a first radio network node to a second radio network node, indicating one or more time sensitive QoS flows to be setup with a tunnel.

41. The method according to claim 36, comprising transmitting a data forwarding indication that data is forwarded for the time sensitive QoS flow.

42. A network node for handling communication in a communication network, wherein the network node comprises:
a communication interface configured for communication with one or more other nodes in the communication network; and
processing circuitry that is operatively associated with the communication interface and configured to set up a separate tunnel for a time sensitive quality of service (QoS) flow.

43. The network node according to claim 42, wherein the processing circuitry is configured to set up the separate tunnel by associating the time sensitive QoS flow of a with an uplink transport tunnel.

44. The network node according to claim 42, wherein the processing circuitry is configured to receive a message from a radio network node, wherein the message is received via the communication interface and contains an indication that indicates support for setting up time sensitive QoS flows for separate tunnels.

45. The network node according to claim 42, wherein the processing circuitry is configured to set up the separate tunnel by allocating a GPRS tunneling protocol-user plane tunnel (GTP-U TNL) per time sensitive QoS flow in a protocol data unit (PDU) session.

46. The network node according to claim 42, when a protocol data unit (PDU) session contains one time sensitive QoS flow and one or more non-time sensitive QoS flows, the separate tunnel is used for the time sensitive QoS flow of the PDU session and another tunnel is setup for the one or more non-time sensitive QoS flows.

47. A radio network node for handling communication of a user equipment (UE) in a communication network, wherein the radio network node comprising:
a communication interface configured for communicating with one or more other nodes of the communication network; and
processing circuitry that is operatively associated with the communication interface and is configured to set up a separate tunnel for a time sensitive quality of service (QoS) flow.

48. The radio network node according to claim 47, wherein the radio network node is configured to set up the separate tunnel by associating the time sensitive QoS flow with an uplink transport tunnel.
